(19) United States
(12) Patent Application Publication
(10) Pub. No.: US 2006/0201918 A1
(43) Pub. Date: Sep. 14, 2006

(54) Heater for semiconductor manufacturing device

(75) Inventors: Tomoyuki Awazu, Itami-shi (JP); Hirohiko Nakata, Itami-shi (JP); Akira Kuibira, Osaka (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Sumitomo Electric Industries, Ltd., Osaka-shi (JP)

(21) Appl. No.: 11/339,430

(22) Filed: Jan. 26, 2006

(30) Foreign Application Priority Data
Jan. 26, 2005 (JP) 017783/2005

(51) Int. Cl. B23K 9/00; B23K 9/02

(52) U.S. Cl. 219/121.52

(57) ABSTRACT

A heater that enables a more even temperature distribution in the time from commencement of heating until completion of cooling, and a device is equipped with the same, are provided. The heater for a semiconductor fabrication device of the present invention comprises a substrate having a heating surface that heats an article to be processed that is placed thereupon or separated therefrom by a set distance and a resistive heating element. The heat capacity of the substrate forms a distribution within the substrate. The substrate, or a portion thereof, is preferably made from one type of metal or a composite of two or more types of metal.

### BACKGROUND OF THE INVENTION

1. Technical Field

The present invention relates to heaters on which an article to be heated is loaded, and to equipment in which such heaters are installed. More specifically, it relates to heaters that are designed for use in semiconductor fabrication devices, in particular for heating semiconductor wafers, and to heating devices in which such heaters are installed.

2. Description of the Related Art

Conventionally, in a semiconductor fabrication process, a semiconductor substrate to be processed (i.e., wafer) is subject to a variety of processes, such as film growth and etching. In a semiconductor fabrication device that carries out such processes on semiconductor substrates, a heater is used both to retain and to heat the semiconductor substrate.

For example, in photolithography processes, a patterned resist film is formed on a wafer. In this process, after the wafer is washed, heated, dried and cooled, the resist film is coated on the wafer surface, the wafer is loaded on a heater within a photolithography device and dried, and then exposure, development and associated processes are carried out. In such photolithography processes, because the temperature when drying or baking the resist has a significant effect on the quality of the resist coating, uniformity of temperature of the heater during the processes is crucial.

Moreover, to improve throughput, the foregoing processes must be completed in as short a time as possible. For this reason, inventors have considered semiconductor fabrication devices that have cooling means for cooling a heated heater in a short time. For example, Japanese Unexamined Pat. App. Pub. No. 2004-014655 proposes a semiconductor fabrication device furnished with a cooling module that can come in contact with, and separate from, the heater surface opposite the surface onto which the wafer is loaded.

Japanese Pat. App. No. 2003-387741 proposes forming a cooling liquid flow path in a cooling module, and a semiconductor fabrication device wherein the temperature of the heater is kept uniform from commencement of cooling to completion of cooling.

In recent electronic and other semiconductor-device fabrication processes, there is even greater demand for a uniform heater temperature distribution; this is true not only while heating to and retaining a temperature, but also from beginning to completion of cooling. There is also a demand for further improvements in heating and cooling speed.

As recent semiconductors have even closer-spaced metallization lines, KrF and ArF lasers are now used as light sources for exposure in the photolithography process, and chemically amplified films are used as the resist films. In such processes, acids generated during exposure serve as catalysts, and in the subsequent development process, the resist films become soluble and can be rinsed off. The temperature in a PEB (post-exposure baking, i.e., post-exposure hardening of a resist film) process, in which a resist film is cured after exposure, causes the acids to disperse, and the degree of movement is largely dependent on temperature. For this reason, to improve photolithography patterning precision, it is necessary to strictly control the resist hardening temperature. In a pre-exposure PAB process (i.e., post applied baking, wherein after a resist film is coated on with a spinner, a solvent is dispersed to increase viscosity, thereby preventing flow during exposure), because post-exposure dispersion of acids is influenced by viscosity of the resist film, there is similarly a need to strictly control temperature. Reactions in a PEB process and PAB process occur during the ramp-up operation, and because irregularity in temperature will have a large effect on pattern precision, it is necessary to strictly control temperature non-uniformity even during the ramp-up operation.

In cases of single wafer processing, in order to increase throughput, wafers are processed one after another at a speed, for example, of one wafer per minute. Usually, when an article to be processed is heated placed upon a heater or with an interval therebetween, the article for processing is placed on the heater at room temperature or in a slightly preheated state. For this reason, after loading, the heater temperature drops; electricity is applied to a resistive heating element in the shape of concentric circles or spiral formed on the heater, causing such resistive heating element to heat up, thereby raising the temperature of the heater and heating the wafer. If after being loaded, a wafer is retained for a long time, the heat gradually disperses and the temperature of the wafer rises uniformly, but throughput does not increase. To increase throughput, while it is extremely difficult to, for example, control heating uniformity in the transition state of about thirty seconds after an article to be processed is placed onto on a heater, there is demand that after a wafer is set onto heaters used in PEB and PAB processes and the temperature drops, the heaters ramp up quickly and that temperature variations in the heaters quickly stabilize.

However, with current heaters, although when the temperature of a heater is constant, it exhibits a relatively good temperature distribution, when the heater is in a transition state, where its temperature is rising, as described above, there is significant temperature non-uniformity in the heater, making it difficult to form a satisfactory, micro-scale metallization patterns with photolithography.

Further, in a PEB or PAB process, the temperature of a heater is frequently changed for processing; for example, after processing at 180° C., the temperature of a heater is lowered by 50° C., for processing at 130° C. In such a case, to increase throughput, it is required that as soon as possible after cooling commences, the heater achieve temperature uniformity.

### BRIEF SUMMARY OF THE INVENTION

It is an object of the present invention to provide a heater, and equipment equipped with the heater, that can achieve a more uniform temperature distribution in the time from commencement of heating until completion of cooling.

The inventors of the present invention, in order to achieve the aforementioned object, as a result of accumulating concerted research efforts, discovered that by creating, in the heat capacity of a heater constituted from a substrate having a heating surface for heating an article to be processed that is loaded thereupon or separated therefrom by a set distance and a resistive heating element, a distribution within the substrate, heat uniformity can be improved.

Thus the heater for a semiconductor fabrication device according to the present invention is a heater constituted by: a substrate having a heating surface that heats an article to be processed loaded thereupon or separated therefrom by a set distance and a resistive heating element, wherein the heat capacity of the substrate is distributed within the substrate.

By lending a distribution to the heat capacity of the heater substrate, a distribution is created for the heat in a substrate at a given temperature. By use of such a substrate, when a wafer placed thereupon is heated, the amount of heat transmitted to the wafer from the substrate at the time a wafer is placed thereupon changes under the influence of the heat capacity distribution of the substrate. As a result, it is possible to alter the distribution and increase/decrease in amount of heat needed for wafer heating, thereby reducing temperature non-uniformity during ramp-up.

It is preferable that such substrate or a portion thereof be made from one type of metal or a metal composite or alloy of two or more metals. Alternatively, it is preferable that such substrate or a portion thereof be made from a composite of metal and a ceramic. With such a constitution, a variety of sizes is possible, and distributed heat capacities can be produced in a variety of forms. As a result, it becomes easy to change the distribution and increase/decrease in heat capacity needed for wafer heating, and temperature non-uniformity during ramp-up can be further reduced.

Further, by giving such substrate a circular plate shape, because wafers used in semiconductor fabrication are usually round, control of the distribution of heat transmitted from substrate to wafer is facilitated, and the temperature distribution of a wafer during ramp-up can be kept low. Further, if the heat capacity distribution is given a concentric shape, control of the distribution of heat transmitted from substrate to wafer is facilitated, and the temperature distribution of a wafer during ramp-up can be kept small.

Moreover, depending on wafer loading method and heating environment, the heat capacity of the substrate can be distributed unidirectionally inclined, thereby facilitating control of the distribution of heat transmitted to a wafer and allowing the temperature distribution of a wafer during ramp-up to be kept low.

By shaping a distribution such that the heat capacity of the substrate changes thickness-wise, the distribution of heat transmitted from substrate to wafer can be controlled. As a result, the temperature distribution of a wafer during ramp-up can be kept low. The form of variation in heat capacity distribution of a substrate can be changed depending upon need for controlling the status of heat movement.

The heat capacity distribution in the substrate can be formed to vary in a step-like manner. By making the distribution thus change in a step-like manner, the heat transmission distribution can be controlled, and wafer temperature profile during ramp-up can be lowered. Alternatively, a continuously varying distribution can be formed. By making the heat capacity change in a continuous manner, the distribution of heat transmitted from substrate to wafer can be made to change gradually, thereby lowering the temperature distribution of a wafer during ramp-up.

The preferable form for such change of substrate heat capacity distribution will be determined depending on such factors as type and size of substrate and heating conditions and environment, and such factors will determine the effectiveness of the aforementioned step-like change or continuous change.

The substrate heat capacity distribution can be shaped by changing substrate thickness so as to correspond to a desired heat capacity distribution. By using a substrate having the distribution of a thickness for forming the required heat capacity distribution, the temperature profile of a wafer during ramp-up can be lowered.

The substrate heat capacity distribution can be shaped by a combination of different materials. By using a substrate wherein a heat capacity distribution is shaped by the combination of different materials, the temperature profile of a wafer during ramp-up can be lowered.

For metal substrate materials, when one or more materials selected from among copper (Cu), aluminum (Al), gold (Ag), tungsten (W), molybdenum (Mo), and silicon (Si), or an alloy thereof, are used, because the foregoing materials have a high heat capacity per volume, the temperature profile of a wafer during ramp-up can be lowered.

Because use of a composite of silicon and silicon carbide (Si—SiC) or a composite of aluminum and silicon carbide (Al—SiC) as the substrate or a portion thereof can result in the creation of a material with the required thermal physical properties, a substrate can be realized having the required heat capacity distribution, so that the temperature profile of a wafer during ramp-up can be lowered.

Further, alumina (Al₂O₃), silicon nitride (Si₃N₄), silicon carbide (SiC), or aluminum nitride (AlN) can be used for a portion of the substrate.

Because aluminum nitride is particularly high in thermal conductivity and has excellent thermal characteristics, it is effective as a substrate material, and use thereof can lower the temperature profile of a wafer during ramp-up.

By using one or more materials selected from among copper (Cu), aluminum (Al), gold (Ag), tungsten (W), molybdenum (Mo), and silicon (Si), or an alloy thereof, and two or more of alumina (Al₂O₃), silicon nitride (Si₃N₄), silicon carbide (SiC), or aluminum nitride (AlN), an effective heat capacity distribution is formed, and the temperature profile of a wafer during ramp-up can be lowered.

The resistive heating element mentioned earlier is divided into a plurality of zones, with each zone being individually controlled, so that areas with a low temperature can receive supply of more electricity during heating, promoting temperature uniformity.

Further, by providing a cooling module, cooling speed when cooling can be increased, enabling greater throughput. Further, by enabling a fluid to flow within a cooling module, more efficient cooling is possible.

Accommodating at least the heater within a metal container makes it less susceptible to the effects of the environment.

By causing a greater amount of heat to be generated at the outer periphery of the resistive heating element, temperature non-uniformity caused by heat escaping from the outer periphery can be rectified.

By plating the surface of the substrate with nickel (Ni) or gold (Au), oxidation and thermal degradation of the substrate can be prevented, and in cases where it is not desirable for the substrate material to infiltrate the wafer, such plating is desirable for preventing impurities, as the materials constituting the substrate are not at the surface thereof.

### BRIEF DESCRIPTION OF THE SEVERAL VIEWS OF THE DRAWINGS

FIG. 1 is a schematic cross-sectional drawing showing one example of a heater of the present invention.

FIG. 2A and FIG. 2B are schematic drawings showing one example of a substrate of the present invention.

FIG. 3A and FIG. 3B are schematic drawings showing another example of a substrate of the present invention.

FIG. 4 is a schematic cross-sectional drawing showing another example of a heater of the present invention.

FIG. 5A and FIG. 5B are schematic drawings showing another example of a substrate of the present invention.

### DETAILED DESCRIPTION OF THE INVENTION

### Best Mode for Carrying Out the Invention

A heater having a resistive heating element will be considered. In a case, for example, where the resistive heating element has a single zone, if the heater has, for example, a circular plate shape, a resistive heating element pattern in the shape of concentric circles or spiral is formed, and the supply of electricity thereto causes the temperature of the heater to rise. If, after heating, the temperature distribution in the steady state is uniform, the outer peripheral portion of the heater, because of the heater's lateral surfaces, must unavoidably be designed so as to generate greater heat. For this reason, when causing the temperature of the heater to rise from a predetermined temperature, because the outer peripheral portions of the heater necessarily rise faster in temperature than the interior portions, the temperature non-uniformity of the heater becomes large, and this is extremely unfavorable when processing a wafer.

Thus, the heater for a semiconductor fabrication device according to the present invention is a heater comprising a substrate having a heating surface that heats an article to be processed that is loaded thereupon or separated therefrom by a set distance and a resistive heating element, wherein the heat capacity of the substrate forms a distribution within the substrate.

The heat capacity of a substrate constituting a heater affects the degree to which temperature of a heater drops when a wafer is loaded thereupon. Specifically, when a substrate has a large heat capacity, the effect from the heat absorbed by a wafer placed thereupon is restricted, and the temperature quickly recovers to the set value. However, if the heat capacity is too large, time is needed for the temperature to recover after a temperature drop. Moreover, while as described above, the substrate temperature after loading of a wafer suffers a drop because of heat absorbed by the wafer, the degree of such temperature drop will be different for different parts of the substrate. Under the simplest conditions, the portion of the substrate upon which the center of a wafer is placed will suffer the largest loss of heat, and thus will have the greatest temperature drop. On the other hand, portions of the substrate onto which a wafer is not placed will undergo only a slight change in amount of heat, and thus the temperature drop therein will be limited. Thus depending on such factors as the size of substrate and wafer and their positional relationship, the impact of a wafer being loaded will result in a temperature distribution reflecting a variety of temperature drops. To rapidly attain a wafer temperature distribution with temperature uniformity, a substrate temperature distribution must be attained; thus such a substrate temperature distribution is a large obstacle to wafer temperature uniformity.

To prevent such an undesirable substrate temperature distribution, substrate temperature drop after wafer loading must be inhibited and control performed such that a desirable temperature distribution is shaped after temperature drop. To shape a temperature distribution favorable to wafer temperature uniformity, the heat needed in view of the heat absorbed by the wafer must be supplied as quickly possible. Further, as described above, the amount of heat absorbed by a wafer is not constant within a wafer, but rather is uneven. In an attempt to address these requirements, it was discovered that, in addition to controlling substrate capacity to inhibit substrate temperature drop, if substrate heat capacity is shaped into a distribution, temperature uniformity in the transition states of rising and falling temperatures are improved. More specifically, by shaping a distribution for substrate heat capacity, it is possible to achieve a substrate temperature distribution favorable for rapidly attaining wafer temperature uniformity, even if heat is absorbed by the wafer.

As material for a substrate or a portion of a substrate constituting a heater, one type of metal or a composite or alloy of two or more metals is used. In place of this metal composite or alloy, a composite of two or metals and a ceramic may be used. More so than ceramic and other materials, there exist metal materials having a variety of thermal capacities, and through a combination thereof, it is possible to create heat capacity distributions with a wide variety of size and form. That is, it is easy to achieve a desirable substrate heat capacity distribution. As a result, it is easy to achieve a substrate temperature distribution favorable for rapidly attaining wafer temperature uniformity.

As far as the method for combining materials is concerned, with metal materials, making compositees or alloys is easy. Because materials have a wide variety of thermal conductivity, a combination can be selected in light of desired thermal conductivity. Further, because metals have large absolute values for heat capacity, substrate volume and thickness can be reduced. In addition, because not only is the material itself inexpensive, there is also a wide variety of manufacturing methods therefor, including casting, forging, plastic working, powder forging, machining and grinding; thus depending on material and desired shape, an appropriate method can be selected, and a substrate inexpensively produced.

Because the temperature distribution of a substrate required for wafer temperature uniformity is determined by such factors as wafer and substrate size, shape and temperature and method of wafer placement, it is not possible to give a uniform stipulation for the shape of the heat capacity distribution of the present invention. However, in the substrate surface direction, the primary forms for such distribution would be concentric or unidirectional; in addition, a heat capacity distribution can also be shaped in the thickness direction.

Possible manners in which a heat capacity distribution can change within a substrate include a step-like change and a continuous change. A step-like change is achieved by providing a substrate with a discontinuous heat capacity distribution. With a discontinuous heat capacity distribution, the distribution of heat transmitted from substrate to wafer can be made to be a distribution with a sharp change or a heat distribution close thereto. By controlling the distribution of heat transmitted from substrate to wafer, wafer temperature profile during ramp-up can be lowered. A step-like change to temperature distribution can be applied to a concentric distribution, unidirectional distribution, distribution in the thickness direction or other desired heat capacity distribution. Further, a step-like thermal distribution may be given to a portion of a substrate or to an entire substrate, and no limitations are placed in such regard.

A substrate heat capacity distribution can also be made to change in a continuous manner. By making heat capacity change in a continuous manner, the distribution of heat transmitted from substrate to wafer can be made to be a distribution having a gradual change, or a heat distribution close thereto. By controlling the distribution of transmitted heat in this manner, wafer temperature profile during ramp-up can be lowered. A step-like change to temperature distribution can be applied to a concentric distribution, unidirectional distribution, distribution in the thickness direction or other desired heat capacity distribution. Further, a continuous thermal distribution may be given to a portion of a substrate or to an entire substrate, and no limitations are placed in such regard.

The preferable form for such change of substrate heat capacity distribution will be determined depending on such factors as type and size of substrate and heating conditions and environment, and such factors will determine the effectiveness of the aforementioned step-like change or continuous change.

To shape a substrate heat capacity distribution, changing substrate thickness is also effective. Because thick portions of a substrate will have a large heat capacity, giving a substrate a thickness distribution can shape its heat capacity distribution. For example, by giving a concentric thickness distribution to a substrate made from the same material, a concentric heat capacity distribution can be shaped. Methods for changing thickness include mechanical processing, casting, welding and the like, but no particular limitations are placed in such regard.

A substrate heat capacity distribution can also be shaped by combining different materials. For example, by stacking a plurality of substrates made from materials of differing heat capacity, a heat capacity distribution in the thickness direction can be shaped. Alternatively, by replacing portions within a substrate with materials of differing heat capacity, a substrate with partially changed heat capacity can be made. By changing the size, shape and heat capacity of the replacement material, the substrate heat capacity distribution can be changed. No particular limitations are placed with regard to number or location of places where a replacement material is to be used, or with regard to the number of types of materials to use.

Methods for combining and attaching different materials include adhesion, welding, screwing and the like, but no particular limitations are placed with regards thereto.

Materials used for a substrate or a portion thereof include inorganic materials such as metals and ceramics, organic materials, and carbon-based materials, as well as composites thereof. For metals, it is preferable that one material selected from among copper (Cu), aluminum (Al), gold (Ag), tungsten (W), molybdenum (Mo), and silicon, or a composite or alloy thereof be used. The foregoing metal materials have a large heat capacity per volume, and thus are materials that facilitate the shaping of a substrate heat capacity distribution.

It is also effective to use as material for a substrate or a portion thereof a composite of silicon and silicon carbide (Si—SiC) or a composite of aluminum and silicon carbide (Al—SiC). Because these materials are composites of materials with differing heat capacity, by changing the composition ratio thereof, materials with a variety of thermal capacities can be created. Further, by changing the composition ratio within a single composite material, it is possible to realize a material having the required heat capacity distribution.

For a ceramic material to be used for a portion of a substrate, use of any of alumina (Al₂O₃), silicon nitride (Si₃N₄), silicon carbide (SiC) or aluminum nitride (AlN) is desirable. These materials have superior mechanical and thermal properties, and as ceramics are relatively inexpensive. Among these, aluminum nitride in particular is a material with high thermal conductivity, and is therefore effective as a substrate.

To shape a heat capacity distribution in a substrate, it is effective to use one or more materials selected from among copper (Cu), aluminum (Al), gold (Ag), tungsten (W), molybdenum (Mo), and silicon, or an alloy thereof, together with two or more materials selected from among alumina (Al₂O₃), silicon nitride (Si₃N₄), silicon carbide (SiC) or aluminum nitride (AlN). Alternatively, the foregoing may be used for a portion of a substrate.

By combining such materials, a variety of heat capacity distributions can be shaped in a relatively easy manner, and by controlling the distribution of heat transmitted from substrate to wafer, the temperature profile of a wafer during ramp-up can be lowered.

No particular limitations are placed with respect to the material for a heater of the present invention, but use of a ceramic is preferable. When a metal is used as material for a heater, due to the friction and chafing between the article to be heated and the heater, particles are generated. Particularly when the article to be heated is a silicon wafer, because the silicon wafer is harder than metal, particles are generated by the friction and chafing with a metallic heater, and such generated particles adhere to the wafer, generating defects. However, because in general ceramics are harder than silicon wafers, there is significantly less generation of particles through chafing and friction, and for this reason use of ceramics is preferable.

A variety of types of ceramics can be selected as the ceramic material. In particular, to inhibit the generation of particles, use a ceramic with as few pores and other defects as possible is preferable. In particular, use of a ceramic with porosity of no greater than 1% is preferable, as the generation of particles is thereby inhibited. By contrast, if the porosity is greater than 1%, the edges of pores on the surface rub and chafe against a wafer or other article placed thereupon, increasing the likelihood of particle generation, and for this reason such materials are not preferable. Provided that the porosity is no greater than 1%, any material appropriate for the intended use may be selected. If priority is placed on uniformity of temperature distribution of the surface of the heater on which a wafer is to be placed, use of aluminum nitride or silicon carbide, which have high thermal conductivity, is preferable. If priority is placed on dependability, as in mechanical strength, then silicon nitride, which has good hardness and is strong against thermal impact, is preferable. If priority is placed on cost, then aluminum oxide is preferable.

Among these ceramics, if a performance-cost balance is taken into consideration, aluminum nitride (AlN), with its high thermal conductivity and superior resistance to corrosion, is ideally suitable. In the following, a method by the present invention of manufacturing a heater in an AlN instance will be described in detail.

The starting material particles of AlN preferably have a specific surface area of 2.0 to 5.0 m²/g. If the specific surface area is less than 2.0 m²/g, because the aluminum nitride particles are relatively large, sinterability degrades. For this reason, sintering cannot be carried out unless at a sintering temperature in excess of 2000° C.; in a case, for example, where a furnace using carbon is used as a sintering furnace, the carbon vapor pressure at time of sintering rises, and such situation is not desirable, as the carbon degradation speed increase.

If the specific surface area exceeds 5.0 m²/g, the particle coherence becomes extremely strong, making handling difficult. More specifically, if the specific surface area becomes too strong, the particle coherence becomes strong, and miscibility with a sintering promoter degrades and sintering temperature increases, and for the same reasons as described above this situation is not desirable. Moreover, when the particle specific surface area is large, this leads to a relative increase in the amount of oxygen present on the surface of the AlN particles and a lowering of the thermal conductivity of the sinters, and for this reason is not desirable.

Furthermore, the quantity of oxygen contained in the starting-material powder is preferably 2 wt. % or less. In sintered form, its thermal conductivity deteriorates if the oxygen quantity is in excess of 2 wt. %. It is also preferable that the amount of metal impurities contained in the starting-material powder other than aluminum be 2000 ppm or less. The thermal conductivity of the powder in sintered form deteriorates if the amount of metal impurities exceeds this range. In particular, the content respectively of Group IV elements such as Si, and elements of the iron family, such as Fe, which have a serious worsening effect on the thermal conductivity of the sinter, is advisably 500 ppm or less.

Because AlN is not a readily sinterable material, adding a sintering promoter to the AlN starting material powder is advisable. The sintering promoter added preferably is a rare-earth element compound. Since rare-earth element compounds react with aluminum oxides or aluminum oxynitrides present on the surface of the particles of the aluminum nitride powder, acting to promote densification of the aluminum nitride and to eliminate oxygen being a causative factor that worsens the thermal conductivity of an aluminum nitride sinter, they enable the thermal conductivity of aluminum sinters to be improved.

Yttrium compounds, whose oxygen-eliminating action is particularly pronounced, are preferable rare-earth element compounds. The amount added is preferably 0.01 to 5 wt. %. If less than 0.01 wt. %, producing ultrafine sinters is problematic, along with which the thermal conductivity of the sinters deteriorates. Added amounts in excess of 5 wt. % on the other hand lead to sintering promoter being present at the grain boundaries in an aluminum nitride sinter, and consequently, if the aluminum nitride sinter is employed under a corrosive atmosphere, the sintering promoter present along the grain boundaries gets etched, becoming a source of loosened grains and particles. More preferably the amount of sintering promoter added is 1 wt. % or less. If 1 wt. % of less, sintering promoter will no longer be present even at the grain boundary triple points, which improves the corrosion resistance.

To characterize the rare-earth compounds further: oxides, nitrides, fluorides, and stearic acid compounds may be employed. Among these, oxides, being inexpensive and readily obtainable, are preferable. By the same token, stearic acid compounds are especially suitable since they have a high affinity for organic solvents, and if the aluminum nitride starting-material powder, sintering promoter, etc. are to be mixed together in an organic solvent, the fact that the sintering promoter is a stearic acid compound will heighten the miscibility.

Next, the aluminum nitride starting-material powder, sintering promoter as a powder, a predetermined volume of solvent, a binder, and further, a dispersing agent or a coalescing agent added as needed, are mixed together. Possible mixing techniques include ball-mill mixing and mixing by ultrasound. Mixing can thus produce a starting material slurry.

The obtained slurry can be molded, and by sintering the molded product, an aluminum nitride sinter can be produced. Co-firing and post-metallization are two possible methods as a way of doing this.

Post-metallization will be described first. Granules are prepared from the slurry by means of a technique such as spray-drying. The granules are inserted into a predetermined mold and subject to press-molding. The pressing pressure therein desirably is 9.8 MPa or more. With pressure less than 9.8 MPa, in most cases sufficient strength in the molded mass cannot be produced, making it vulnerable to breaking when handled.

Although the density of the molded mass will differ depending on the amount of binder contained and on the amount of sintering promoter added, preferably it is 1.5 g/cm³ or more. Densities less than 1.5 g/cm³ would mean a large inter-particle distance in the starting-material powder, which would hinder the progress of the sintering. At the same time, the molded mass density preferably is 2.5 g/cm³ or less. Densities of more than 2.5 g/cm³ would make it difficult to eliminate sufficiently the binder from within the molded mass in a degreasing process of a subsequent step. It would consequently prove difficult to produce an ultrafine sinter as described earlier.

Next, heating and degreasing processes are carried out on the molded mass within a non-oxidizing atmosphere. Carrying out the degreasing process under an oxidizing atmosphere such as air would degrade the thermal conductivity of the sinter, because the AlN powder would become superficially oxidized. Preferable non-oxidizing ambient gases are nitrogen and argon. The heating temperature in the degreasing process is preferably 500° C. or more and 1000° C. or less. With temperatures of less than 500° C., surplus carbon is left remaining within the laminate following the degreasing process because the binder cannot sufficiently be eliminated, which interferes with sintering in the subsequent sintering step. On the other hand, at temperatures of more than 1000° C., the ability to eliminate oxygen from the oxidized coating superficially present on the surface of the AlN powder deteriorates, such that insufficient carbon remains, degrading the thermal conductivity of the sinter.

The amount of carbon remaining within the molded body after the degreasing process is preferably 1.0 wt. % or less. If carbon in excess of 1.0 wt. % remains, it will interfere with the sintering, which would mean that ultrafine sinters could not be produced.

Next, sintering is carried out. The sintering is carried out within a non-oxidizing nitrogen, argon, or like atmosphere, at a temperature of 1700 to 2000° C. Therein the moisture contained in the ambient gas such as nitrogen that is employed is preferably −30° C. or less given in dew point. If it were to contain more moisture than this, the thermal conductivity of the sinter would likely be degraded, because the AlN would react with the moisture within the ambient gas during sintering and form nitrides. Another preferable condition is that the volume of oxygen within the ambient gas be 0.001 vol. % or less. A larger volume of oxygen would lead to a likelihood that the AlN would oxidize, impairing the sinter thermal conductivity.

As another condition during sintering, the jig employed is suitably a boron nitride (BN) molded part. Inasmuch as the jig as a BN molded part will be sufficiently heat resistant against the sintering temperatures, and superficially will have solid lubricity, when the laminate contracts during sintering, friction between the jig and the laminate will be lessened, which will enable sinters to be produced with little warpage, that is, with little deformation.

The obtained sinter is subjected to processing according to requirements. In cases where a conductive paste is to be screen-printed onto the sinter in a succeeding step, the surface roughness is preferably 5 μm or less Ra. If over 5 μm, in screen printing to form circuits, defects such as blotting or pinholes in the pattern are liable to arise. More suitable is a surface roughness of 1 μm or less Ra.

In polishing to the abovementioned surface roughness, although cases in which both sides of the sinter are screen printed are a matter of course, even in cases where screen printing is effected on one side only the polishing process is best carried out on the face on the side opposite the screen-printing face. This is because polishing only the screen-printing face would mean that during screen printing, the sinter would be supported on the unpolished face, and in that situation burrs and debris would be present on the unpolished face, destabilizing the fixedness of the sinter such that the circuit pattern by the screen printing might not be drawn well.

Furthermore, at this point the thickness uniformity (parallelism) along either processed face is preferably 0.5 mm or less. Thickness uniformity exceeding 0.5 mm can lead to large fluctuations in the thickness of the conductive paste during screen printing. Particularly suitable is a thickness uniformity of 0.1 mm or less. Another preferable condition is that the planarity of the screen-printing face be 0.5 mm or less. If the planarity exceeds 0.5 mm, in that case too there can be large fluctuations in the thickness of the conductive paste during screen printing. Particularly suitable is a planarity of 0.1 mm or less.

Screen printing is used to spread a conductive paste and form the electrical circuits onto a sinter having undergone the polishing process. The conductive paste can be obtained by mixing together with a metal powder an oxidized powder, a binder, and a solvent according to requirements. The metal powder is preferably tungsten, molybdenum or tantalum, since their thermal expansion coefficients match those of ceramics. Alternatively, a mixture or alloy of silver, palladium, platinum or the like may be used.

Adding the oxidized powder to the conductive paste is also to enhance the strength with which it bonds to AlN. The oxidized powder preferably is an oxide of Group IIa or Group IIIa elements, or is Al ₂O₃, SiO₂, or a like oxide. Yttrium oxide is especially preferable because it has very good wettability with AlN. The amount of such oxides added is preferably 0.1 to 30 wt. %. If the amount is less than 0.1 wt. %, the bonding strength between AlN and the metal layer being the circuit that has been formed deteriorates. On the other hand, amounts in excess of 30 wt. % make the electrical resistance of the circuit metal layer high.

These powders are sufficiently mixed, binder and solvent are added, and a conductive paste is made.

With this a circuit pattern is formed by screen printing. The thickness of the conductive paste is preferably 5 μm or more and 100 μm or less in terms of its post-drying thickness. If the thickness were less than 5 μm the electrical resistance would be too high and the bonding strength would decline. Likewise, if in excess of 100 μm the bonding strength would deteriorate in that case too.

Also preferable is that the pattern spacing be 0.1 mm or more in the resistive heating element to be formed. With a spacing of less than 0.1 mm, shorting will occur when current flows in the resistive heating element and, depending on the applied voltage and the temperature, leakage current is generated. Particularly in cases where the circuit is employed at temperatures of 500° C. more, the pattern spacing preferably should be 1 mm or more; more preferable still is that it be 3 mm or more. In addition to resistive heating element patterns, RF patterns and electrodes for static electricity chucks can be formed by screen printing.

After the conductive paste is degreased, baking follows. Degreasing is carried out within a non-oxidizing nitrogen, argon, or like atmosphere. The degreasing temperature is preferably 500° C. or more. At less than 500° C., elimination of the binder from the conductive paste is inadequate, leaving behind carbon in the metal layer that during baking will form carbides with the metal.

The baking is suitably done within a non-oxidizing nitrogen, argon, or like atmosphere at a temperature of 1500° C. or more. At temperatures of less than 1500° C., the post-baking electrical resistance of the metal layer turns out too high because the baking of the metal powder within the paste does not proceed to the grain growth stage. A further baking parameter is that the baking temperature should not surpass the firing temperature of the ceramic produced. If the conductive paste is baked at a temperature beyond the firing temperature of the ceramic, dispersive volatilization of the sintering promoter incorporated within the ceramic sets in, and moreover, grain growth in the metal powder within the conductive paste is accelerated, impairing the bonding strength between the ceramic and the metal layer.

In order to ensure that the metal layer is electrically isolated, an insulative coating can be formed on the metal layer. Use of the same material as the ceramic on which the metal layer is formed is preferable. This is because if the compositions of the ceramic and of the insulative coating are widely divergent, the respective coefficients of thermal expansion will also be different, leading to such problems as warpage after baking. For example, in the case where the ceramic material is aluminum nitride, to aluminum nitride, a predetermined amount of a Group IIa, Group IlIa oxide or carbonate is added as sintering promoter; after mixing, a binder and solvent are added, the mixture is rendered into a paste, which is applied to the metal layer by screen-printing. In this case, the amount of sintering promoter added preferably is 0.01 wt. % or more. With an amount less than 0.01 wt. % the insulative coating does not densify, making it difficult to secure electrical isolation of the metal layer. It is further preferable that the amount of sintering promoter not exceed 20 wt. %. Surpassing 20 wt. % leads to excess sintering promoter invading the metal layer, which can end up altering the metal-layer electrical resistance.

Although not particularly limited, the spreading thickness preferably is 5 μm or more. This is because securing electrical isolation proves to be problematic at less than 5 μm.

If tungsten or other metal with a high melting point is used as materials for the metal layer, glass ceramic, glass glaze, an organic resin or the like is applied, then baked or cured, thereby forming an insulative layer. The types of glass that may be employed include boron silicate glass, lead oxide, zinc oxide, aluminum oxide, and silicon oxide. Into powders of these an organic solvent and a binder are added, the combination is rendered into paste form, and the paste is screen-printed to coat it on. Although the coating thickness is not particularly restricted, preferably it is 5 μm or more. This is because securing insulating properties proves to be problematic at less than 5 μm. While no particular restrictions are placed with respect to baking temperature at this time, because a metal layer does not oxidation-resistant properties, it is preferable to bake in an inert gas atmosphere, such as a nitrogen or argon atmosphere.

As far as materials for the conductive paste are concerned, mixtures or alloys of metals such as silver, palladium and platinum can be employed. With these metals, inasmuch as the volume resistivity of a conductor is increased by adding palladium or platinum to silver content, an amount added should be adjusted depending on the circuit pattern. Likewise, inasmuch as these additives are effective for preventing electromigration between circuit patterns, adding 0.1 or more parts by weight to 100 parts by weight silver is advantageous.

Adding metal oxides to powders of these metals is advisable in order to ensure the bondability of the metals with AlN. Oxides that may be added include, for example, aluminum oxide, silicon oxide, copper oxide, boron oxide, zinc oxide, lead oxide, rare earth oxides, transition metal group oxides, and alkaline earth metal oxides. Preferable as the amount added is 0.1 wt. % or more but 50 wt. % or less. Content less than this range would be undesirable because the bondability with aluminum nitride would deteriorate. Likewise, content greater than this range would be disadvantageous because it would interfere with sintering of the metal components such as silver.

The circuits may be formed by mixing powders of these metals with powdered inorganic substances, then adding an organic solvent and a binder, rendering the mixture into paste form, and screen printing the paste in the manner noted above. Baking circuit patterns formed in this case is within a nitrogen or like inert gas atmosphere, or else within air, at a temperature in a range of from 700° C. to 1000° C.

In this case furthermore, in order to ensure electrical isolation between circuits, an insulating layer may be formed by coating on a material such as glass-ceramic, glass glaze, or an organic resin, and baking or else curing the material. The types of glass that may be employed include boron silicate glass, lead oxide, zinc oxide, aluminum oxide, and silicon oxide. Into powders of these an organic solvent and a binder are added, the combination is rendered into paste form, and the paste is screen-printed to coat it on. Although the coating thickness is not particularly restricted, preferably it is 5 μm or more. This is because securing insulating properties proves to be problematic at less than 5 μm. Furthermore, the baking temperature preferably is lower than the temperature when forming the circuits described above. Baking at a temperature higher than that during the aforementioned circuit baking would be undesirable because the resistance of the circuit patterns would be altered significantly.

Further according to the present method, the ceramic as substrates can be laminated according to requirements. Lamination may be done via a bonding agent. The bonding agent—being a compound of Group IIa or Group IIIa elements, and a binder and solvent, added to an aluminum oxide powder or aluminum nitride powder and made into a paste—is spread onto the bonding surface by a technique such as screen printing. The thickness of the applied bonding agent is not particularly restricted, but preferably is 5 μm or more. Bonding defects such as pin-holes and bonding irregularities are liable to arise in the bonding layer with thicknesses of less than 5 μm. Because at such time, the formed metal layer may react with the bonding layer, it is more preferable to form on the metal layer a protective layer having aluminum nitride, as described above, as the primary component.

The ceramic substrates onto which the bonding agent has been spread are degreased within a non-oxidizing atmosphere at a temperature of 500° C. or more. The ceramic substrates are thereafter bonded to one another by stacking the ceramic substrates together, applying a predetermined load to the stack, and heating it within a non-oxidizing atmosphere. The load preferably is 5 kPa or more. With loads of less than 5 kPa sufficient bonding strength will not be obtained, and otherwise defects in the bond will likely occur.

Although the heating temperature for bonding is not particularly restricted as long as it is a temperature at which the ceramic substrates adequately bond to one another via the bonding layers, preferably it is 1500° C. or more. At less than 1500° C. adequate bonding strength proves difficult to gain, such that defects in the bond are liable to arise. Nitrogen or argon is preferably employed for the non-oxidizing atmosphere during the degreasing and boding just discussed.

A ceramic sinter laminate that serves as a substrate for a heater thus can be produced as in the foregoing. As far as the electrical circuits are concerned, it should be understood that if they are heater circuits for example, then a molybdenum coil can be utilized, and in the electrostatic-chuck electrode and RF electrode cases, molybdenum or tungsten mesh can be used, without employing conductive paste.

In this case, the molybdenum coil or the mesh can be built into the AlN starting material powder, and the heater can be fabricated by hot pressing. While the temperature and atmosphere in the hot press may be on par with the AlN sintering temperature and atmosphere, the hot press desirably applies a pressure of 0.98 MPa or more. With pressure of less than 0.98 MPa, the heating might not exhibit its capabilities as a heater, because gaps arise between the AlN and the molybdenum coil or the mesh.

Co-firing will now be described. The earlier-described starting material slurry is molded into a sheet by doctor blading. The sheet-molding parameters are not particularly limited, but the post-drying thickness of the sheet advisably is 3 mm or less. Sheet thickness surpassing 3 mm leads to large shrinkage in the drying slurry, raising the probability that fissures will be generated in the sheet.

A metal layer of predetermined form that serves as an electrical circuit is formed onto the abovementioned sheet using a technique such as screen printing to spread onto it a conductive paste. The conductive paste utilized can be the same as that which was described under the post-metallization method. Nevertheless, not adding an oxidized powder to the conductive paste does not hinder the co-firing method.

Subsequently, sheets that have undergone circuit formation are laminated with sheets that have not. Lamination is by setting the sheets each into position to stack them together. Therein, according to requirements, a solvent is spread between sheets. In the stacked state, the sheets are heated as may be necessary. In cases where the stack is heated, the heating temperature is preferably 150° C. or less. Heating to temperatures in excess of this greatly deforms the laminated sheets. Pressure is then applied to the stacked-together sheets to unitize them.

The applied pressure is preferably within a range of from 1 to 100 MPa. At pressures less than 1 MPa, the sheets are not adequately unitized and can peel apart during subsequent processes. Likewise, if pressure in excess of 100 MPa is applied, the extent to which the sheets deform becomes too great.

This laminate undergoes a degreasing process as well as sintering, in the same way as with the post-metallization method described earlier. Parameters such as the temperature in degreasing and sintering and the amount of carbon are the same as with post-metallization. In the previously described screen printing of a conductive paste onto sheets, an electric conduction heating heater having a plurality of electrical circuits can be readily fabricated by printing heater circuits, electrostatic-chuck electrodes, etc. respectively onto a plurality of sheets and laminating them. In this way a ceramic laminated sinter that serves as a heater substrate can be produced.

It will be appreciated that in cases in which an electrical circuit such as a heat generating circuit is to be formed on the outermost layer of the ceramic laminate, an insulative coating can be formed onto the circuit likewise as with the afore-described post-metallization method in order to protect the electrical circuit and to ensure it is electrically isolated.

In the present invention, the resistive heating element pattern can be divided into a plurality of zones. Although the form of such division is not particularly restricted, it is preferable to divide in a manner such that the temperature distribution of the heater is uniform during ramp-up of the heater. More specifically, the resistive heating element can be divided into an outer periphery portion and inner periphery portion. Because it is unavoidable that the temperature of the outer periphery portion of a heater will increase during ramp-up, such a configuration is preferable, as output thereto can be restrained in comparison to output to the inner periphery portion, and ramp-up carried out in such a way that the difference in temperature between inner and outer portion is kept to the minimum degree possible. Division may be into two zones, but for reasons of temperature distribution, division into three or more zones is preferable. However, increase in number of zones entails an increase in control devices and output devices, and thus an increase in costs. In view of these competing factors, control using two or three zones is preferable. In particular, given the recent strong demands regarding temperature distribution, control using three zones is preferable because of the excellent heat uniformity afforded.

Furthermore, in a case where a wafer at room temperature is to be loaded on a heater heated to a predetermined temperature, the temperature of the central portion of the wafer will drop; in such a case, with a resistive heating element circuit divided into a plurality of concentric zones, the temperature distribution can be kept low. More specifically, it is preferable to restrict output to the outer periphery portion, and increase output to the inner periphery portion and central portion, thereby attaining an even heater temperature distribution, that is, uniform wafer temperature.

In addition, the present invention may be equipped with a cooling module. When a need arises to cool a heater, a cooling module is brought into contact therewith and absorbs heat therefrom, thereby rapidly cooling the heater. With such a configuration, the heater cooling speed can be significantly improved, enabling greater throughput. Although no particular restrictions are placed with regard to the material of a cooling module, use of aluminum, copper or an alloy thereof is preferable, because of the comparatively high thermal conductivity of such metals. Stainless steel, a magnesium alloy, nickel, or other metal material can also be used. To impart oxidation-resistance to a cooling module, a metal film of nickel, gold, silver or the like, having oxidation-resistant properties, can be formed by plating, spraying or other method.

As far as the material of this cooling module is concerned, a ceramic can also be used. Although there are no particular restrictions with respect to materials in such a case, aluminum nitride and silicon carbide are preferable, as their relatively high thermal conductivity enables the rapid absorption of heat from a heater. Silicon nitride and aluminum oxynitrides are also preferable for their superior mechanical strength and durability. Oxide ceramics such as alumina, cordelite or steartite are also preferable for their relatively low cost. It will be apparent from the foregoing descriptions that a material for a cooling module can be selected from a variety of materials, depending on the intended use. In particular, from among these materials, aluminum plated with nickel is particularly preferable, because of its superior oxidation resistance, high thermal conductivity, light weight, and comparatively low cost.

It is also possible to configure a cooling module such that a coolant flows therein. With such a configuration, heat transmitted from heater to cooling module can be quickly removed, thereby further improving heater cooling speed. A coolant inside a cooling module can be selected from among such materials as water and Fluorinert™, and no particular restrictions are placed with respect thereto, but in consideration of specific heat and cost, water is most preferable. The most preferable mode for a cooling module will now be explained. Two aluminum sheets are prepared, upon one of which a channel for water is formed by mechanical processing or other such method and nickel plating carried out for the purpose of improving corrosion resistance and oxidation resistance. The other aluminum sheet, which has also been nickel-plated, is then laminated thereto. Lamination is carried out by inserting an O-ring or the like to prevent water from leaking from the channel, and joining the two sheets by screwing or welding. Alternatively, a metal or resin pipe can be used for a channel. In such a case, such pipe is attached to an aluminum sheet by screwing or welding to form a cooling module.

Planarity is controlled so that total of the planarity of the cooling-module contacting surface of the heater and the planarity of the heater-contacting surface of the cooling module is no greater than 0.8 mm. More preferably, the total planarity is no greater than 0.4 mm. Proposals have been made in the conventional art for improving the planarity and surface roughness of the primary surface of the heater onto which a wafer is to be loaded, thereby imparting an event temperature distribution to an article to be heated, but no proposals have been made for a heater unit having a cooling module, wherein the planarity of the contact surfaces of both a heater and cooling module is improved to make temperature distribution even and thereby improve cooling speed.

By securing the planarity of both the surface of the heater in contact with the cooling module and the surface of the cooling module in contact with the heater, the heater and cooling module are in uniform contact with each other across their entire respective surfaces, resulting in heightened contact therebetween. Thus thermal conductivity improves, and when a cooling module is brought in contact with a heater, the cooling speed improves; further, because the entire under surface of a heater is evenly cooled, the temperature distribution of a heater during cooling has greater evenness.

If planarity of only one of the surface of the heater in contact with the cooling module and the surface of the cooling module in contact with the heater is secured, the above-described effects are not obtained. The above effects are attained when the combined planarity of the two surfaces is not greater than 0.8 mm.

To achieve the planarity of the respective contact surfaces of the heater and cooling module, processing such as lapping or grinding using a whetstone may be used. It is preferable that post-processing surface roughness Ra be no greater than 5 μm. Ensuring that the surface roughness Ra of the respective contact surfaces of the substrate and cooling module is no greater than 5 μm results in heightened contact between the heater and cooling module, thereby improving evenness of temperature distribution and cooling speed of the heater.

In particular, by improving the surface roughness of the heater contact surface so that it approaches a mirror finished surface state, the emissivity of such surface falls. When emissivity falls, the amount of heat radiated from such surface decreases, resulting in a reduction in the power needed to heat the heater and a desirable conservation of energy. In a case where the substrate constituting a heater is made from a ceramic material, if the surface roughness is rough, friction with the cooling module at time of contact results in a greater number of particles falling off from the substrate, and these particles have an adverse effect on the quality of the article being heated. For this reason, it is more preferable that the surface roughness Ra be no greater than 1 μm.

Furthermore, in a case of a heater having formed on the under surface thereof a heat generating circuit and an insulative layer protecting such heat generating circuit, if excessive processing is carried out in an attempt to achieve planarity of the surface that comes in contact with the cooling module, the insulative layer grows thin, and in some cases the heat generating circuit may be exposed, leading to the possibility of short-circuiting. To prevent such an occurrence, one approach might be to make the insulative layer thicker, but because the insulative layer has low thermal conductivity, greater thickness leads to greater thermal resistance, and therefore slower cooling speed. For this reason, it is preferable that the thickness of an insulative layer, after processing for attaining planarity has been carried out, be in the range from 15 μm to 500 μm.

If the thickness of an insulative layer is uneven after planarity processing, the thermal resistance will change, leading to fluctuations in cooling speed, and increasing the likelihood of an uneven heater temperature distribution. Therefore, it is desirable that the thickness of an insulative layer after planarity processing be uniform, and it is preferable that the differential between maximum and minimum insulative layer thickness be no greater than 200 μm.

A cooling module is, for example, placed within a container by an air cylinder or other lifting means, and can be brought in contact with or separated from a heater as necessary. This cooling module comprises a through hole through which an electrode for power supply and temperature measurement means can be inserted.

Further, it is preferable that such a heater and cooling module be accommodated in a metal container. Accommodation in such a container is advisable as it eliminates the possibility of the heater temperature distribution being disrupted through the effects of air currents or other such factors, and enables a more uniform thermal distribution to be attained. It is preferable that in such a case, to the extent possible, a set distance be maintained between the accommodating metal container and the heater. The reason for this is that if the heater is close to the container, the amount of heat transmitted to the container relatively increases and the temperature of the heating surface falls, and such a situation is not desirable.

By providing a substrate heater to the wafer placement surface or under surface of the substrate, the temperature non-uniformity of the substrate itself can be corrected. By implementing a design such that the amount of heat generated by the substrate heater is greater at the outer periphery, temperature non-uniformity caused by heat escaping from the outer periphery can be corrected. By plating the substrate surface with nickel or gold, oxidation and thermal degradation of the substrate can be prevented, and in a case where it would be undesirable for the substrate material to mix with the wafer, such plating is advisable in that by keeping such substrate material from the surface, it prevents impurities from entering the wafer.

A heating device equipped with such a heater and cooling module, because it allows the temperature distribution of a heating surface to be even, can be favorably used in a semiconductor fabrication device in which a semiconductor wafer is heated and processed. For example, it can be used as a heater for curing a resin film formed on a wafer, a heat for testing semiconductors, or a film growth, etching or ashing device.

### Embodiment 1

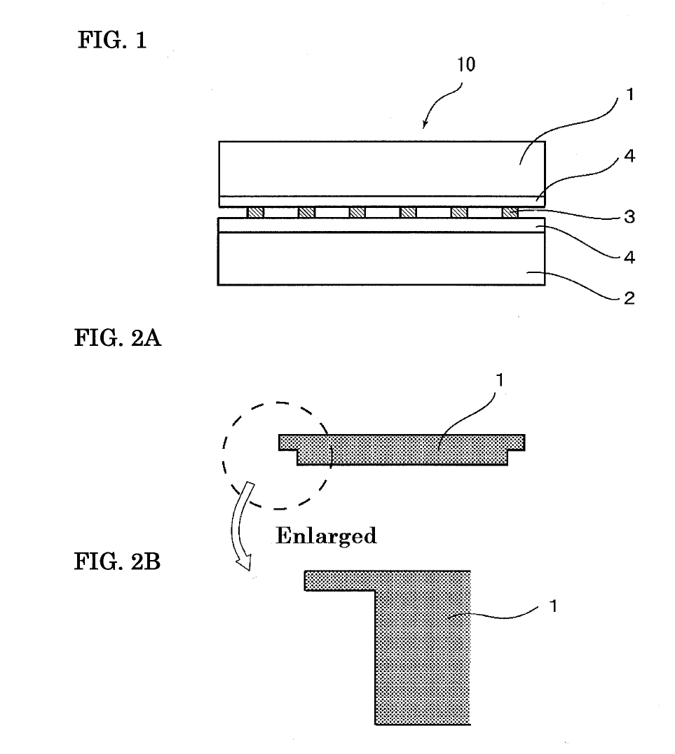

As shown in FIG. 1, a stainless steel resistive heating element 3 of 50 μm thickness and 330 mm diameter, in which the heat generating circuit is made up of three zones, was sandwiched between two polyimide sheets (15 μm thickness) as insulating bodies 4 to form a stainless steel heat-emitting element with a diameter of 330 μm. A substrate A1 was disposed on the top surface of this stainless steel heat-emitting element, and a substrate B2 was disposed on the bottom surface thereof, to fabricate a heater.

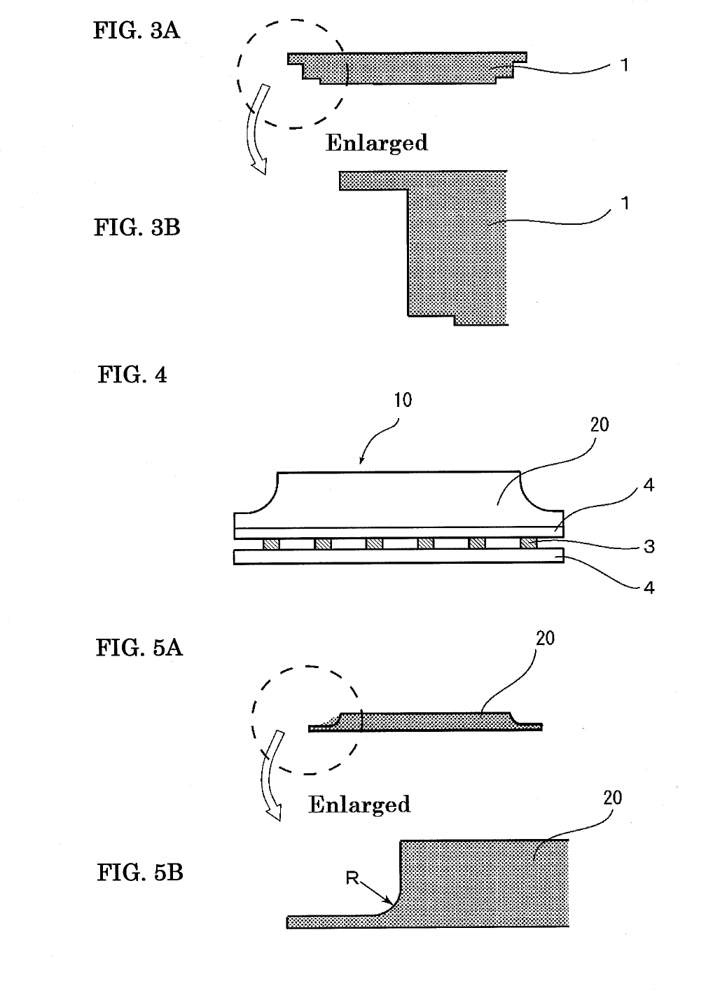

For substrates A, “Cu,” a copper plate, and “AlN,” an aluminum nitride plate, of 330 mm diameter and 3 mm thickness were prepared. For substrates B, “Cu-1,” a copper plate of 330 mm diameter and 12 mm thickness, and, as indicated in FIG. 2, in order to form heat capacities distributed in concentric circular form, “Cu-2” in which the peripheral portion 300 mm or greater diameter of a copper plate of 330 mm diameter, 12 mm thickness was cut away to a depth-of-cut of 10 mm, and as indicated in FIG. 3, “Cu-3,” in which the peripheral portion 300 mm or greater diameter of a copper plate of 330 mm diameter, 12 mm thickness was cut away to a depth-of-cut of 10 mm, and in which the peripheral portion of 280 mm or greater was cut away to a depth-of-cut of 1 mm, were prepared.

The copper sheets were plated with nickel. These substrates 1 and substrates 2 were combined in the manner shown in Table I to form heaters.

Two duralumin sheets with a thickness of 5 mm and a diameter of 330 were prepared, one of which was subject to mechanical processing to form a water channel and then plated with nickel to a depth of 20 μm; the other plate was also nickel plated, the two plates were screwed together with an O-ring sandwiched therebetween, and a cock was attached to serve as water inlet and outlet, thus completing a cooling module.

These heaters and cooling module were placed in a stainless steel container. The heater was heated to a temperature of 130° C., and a room temperature (25° C.) wafer thermometer with a diameter of 300 mm was loaded on a heating surface 10, and the temperature of the wafer thermometer was measured 30 s, 60 s and 5 min after loading. Table I shows as a temperature range the difference between maximum and minimum values of the measured temperatures.

TABLE I

| | Substrate | Substrate | Temperature range (° C.) | | |
|---|---|---|---|---|---|
| | A | B | After 30 s | After 60 s | After 5 min |
| Heater 1-1 | Cu | Cu-1 | 1.03 | 0.35 | 0.32 |
| Heater 1-2 | Cu | Cu-2 | 0.10 | 0.09 | 0.08 |
| Heater 1-3 | Cu | Cu-3 | 0.09 | 0.08 | 0.06 |
| Heater 1-4 | AlN | Cu-1 | 1.73 | 0.45 | 0.46 |
| Heater 1-5 | AlN | Cu-2 | 0.11 | 0.08 | 0.08 |
| Heater 1-6 | AlN | Cu-3 | 0.09 | 0.07 | 0.07 |

As can be seen from Table I, by creating a thickness distribution in the outer periphery portion of the substrate, a heat capacity distribution is shaped, thereby achieving a wafer temperature distribution with temperature uniformity. With heater 1-3, a temperature distribution with a temperature range of 0.09° C. after 30 s and 0.08° C. after 60 s was obtained, and with heater 1-6, a temperature distribution with a temperature range of 0.09° C. after 30 s and 0.07° C. after 60 s was obtained.

### Embodiment 2

As shown in FIG. 4, a stainless steel resistive heating element 3 of the same 50 μm thickness and 330 mm diameter as in the first embodiment was sandwiched between two polyimide sheets 4, and a substrate C20 with a diameter of 330 mm was placed thereupon, thus forming a heater. Two types of substrate C20 were prepared: “Cu-4,” a copper plate of 330 mm diameter and 10 mm thickness was prepared, and, as indicated in FIG. 5, in order to form heat capacities distributed in concentric circular form, “Cu-5,” in which the periphery at 300 mm or greater diameter of a copper plate of 330 mm diameter and 10 mm thickness was scooped away 8 mm at a radius of curvature of 4.0. As with the first embodiment, these heaters and cooling module were installed in a stainless steel container, the temperature of a wafer thermometer was measured 30 s, 60 s and 5 min after loading upon a heating surface 10. The results are set forth, together with the heat capacity and thermal conductivity of the substrates, in Table II. As in the first embodiment, the temperatures heated to were 130° C. and 200° C.

TABLE II

| | | | Temperature range (° C.) | | |
|---|---|---|---|---|---|
| | Temperature | | | | After |
| | (° C.) | Substrate C | After 30 s | After 60 s | 5 min |
| Heater 2-1 | 130 | Cu-4 | 1.00 | 0.24 | 0.23 |
| Heater 2-2 | | Cu-5 | 0.09 | 0.07 | 0.07 |
| Heater 2-3 | 200 | Cu-4 | 1.81 | 0.64 | 0.59 |
| Heater 2-4 | | Cu-5 | 0.17 | 0.13 | 0.11 |

As can be seen from Table II, by creating a thickness distribution in the substrate, a heat capacity distribution is formed, thereby giving the temperature uniformity to a wafer temperature distribution. With heater 2-2 (heated to 130° C.), a temperature distribution with a temperature range of 0.09° C. after 30 s and 0.07° C. after 60 s was obtained, and with heater 2-4 (heated to 200° C.), a temperature distribution with a temperature range of 0.17° C. after 30 s and 0.13° C. after 60 s was obtained.

### INDUSTRIAL APPLICABILITY

In accordance with the present invention, with respect to a heater comprising (a) a substrate having a heating surface that heats an article to be processed placed thereupon or separated therefrom by a set distance and (b) a resistive heating element, forming a heat capacity distribution in such substrate enables a more even heater temperature distribution to be attained, and, in particular, an even temperature distribution in the transition state. An even temperature distribution can be attained in a constant state also. A semiconductor fabrication device or testing device comprising such a heater, or a flat panel display manufacture or testing device, or a photoresist heating device comprising such a heater will have a more even heater temperature distribution than conventional devices, leading to improved characteristics and yield for semiconductors and flat panel displays, and improved dependability, integration and image quality.

What is claimed is:

1. A heater for semiconductor fabrication equipment, the heater constituted from a substrate having a heating surface for heating an article to be processed that is loaded thereupon or separated therefrom by a set distance, and a resistive heating element, characterized in that the heat capacity of the substrate forms a distribution within the substrate.

2. A semiconductor fabrication equipment heater as set forth in claim 1, characterized in that the substrate is made from one type of metal, or a composite or an alloy of two or more types of metal.

3. A semiconductor fabrication equipment heater as set forth in claim 1, characterized in that a portion of the substrate is made from one type of metal, or a composite or an alloy of two or more types of metal.

4. A semiconductor fabrication equipment heater as set forth in claim 1, characterized in that the substrate is made from a composite of a metal and a ceramic.

5. A semiconductor fabrication equipment heater as set forth in claim 1, characterized in that a portion of the substrate is made from a composite of a metal and a ceramic.

6. A semiconductor fabrication equipment heater as set forth in claim 1, characterized in that the substrate is in the form of a circular plate.

7. A semiconductor fabrication equipment heater as set forth in claim 1, characterized in that the thermal capacity of the substrate forms a concentric distribution.

8. A semiconductor fabrication equipment heater as set forth in claim 1, characterized in that the thermal capacity of the substrate forms a unidirectional distribution.

9. A semiconductor fabrication equipment heater as set forth in claim 1, characterized in that the thermal capacity of the substrate forms a distribution that varies thickness-wise.

10. A semiconductor fabrication equipment heater as set forth in claim 1, characterized in that the thermal capacity of the substrate forms a distribution that varies in a stepwise fashion.

11. A semiconductor fabrication equipment heater as set forth in claim 1, characterized in that the thermal capacity of the substrate forms a distribution that varies continuously.

12. A semiconductor fabrication equipment heater as set forth in claim 1, characterized in that the thermal capacity of the substrate is formed by changing the thickness of the substrate.

13. A semiconductor fabrication equipment heater as set forth in claim 1, characterized in that the thermal capacity of the substrate is formed by combining different types of materials.

14. A semiconductor fabrication equipment heater as set forth in claim 1, characterized in that the substrate is composed of one or more materials selected from among copper (Cu), aluminum (Al), gold (Ag), tungsten (W), molybdenum (Mo), and silicon (Si), or an alloy thereof.

15. A semiconductor fabrication equipment heater as set forth in claim 1, characterized in that the substrate is a composite of silicon and silicon carbide (Si—SiC) or a composite of aluminum and silicon carbide (Al—SiC).

16. A semiconductor fabrication equipment heater as set forth in claim 1, characterized in that a portion of the substrate is a composite of silicon and silicon carbide (Si—SiC) or a composite of aluminum and silicon carbide (Al—SiC).

17. A semiconductor fabrication equipment heater as set forth in claim 1, characterized in that a portion of the substrate is alumina (Al₂O₃), silicon nitride (Si₃N₄), silicon carbide (SiC), or aluminum nitride (AlN).

18. A semiconductor fabrication equipment heater as set forth in claim 17, characterized in that a portion of the substrate is aluminum nitride (AlN).

19. A semiconductor fabrication equipment heater as set forth in claim 1, characterized in that the substrate is composed of one or more materials selected from among copper (Cu), aluminum (Al), gold (Ag), tungsten (W), molybdenum (Mo), and silicon (Si), or an alloy thereof, and two or more of alumina (Al₂O₃), silicon nitride (Si₃N₄), silicon carbide (SiC), or aluminum nitride (AlN).

20. A semiconductor fabrication equipment heater as set forth in claim 1, characterized in that a portion of the substrate is made from one or more materials selected from among copper (Cu), aluminum (Al), gold (Ag), tungsten (W), molybdenum (Mo), and silicon (Si), or an alloy thereof, and two or more of alumina (Al₂O₃), silicon nitride (Si₃N₄), silicon carbide (SiC), or aluminum nitride (AlN).

21. A semiconductor fabrication equipment heater as set forth in claim 1, characterized in that the resistive heating element is divided into a plurality of zones and each zone can be independently controlled.

22. A semiconductor fabrication equipment heater as set forth in claim 1, characterized in being equipped with a cooling module.

23. A semiconductor fabrication equipment heater as set forth in claim 22, characterized in that fluid can flow through the cooling module.

24. A semiconductor fabrication equipment heater as set forth in claim 1, characterized in that at least the heater is accommodated in a metal container.

25. A semiconductor fabrication equipment heater as set forth in claim 1, characterized in that the amount of heat emitted along the outer periphery of the resistive heating element is large.

26. A semiconductor fabrication equipment heater as set forth in claim 1, characterized in that the surface of the substrate is plated with nickel (Ni) or gold (Au).
